(19) United States
(12) Patent Application Publication
(10) Pub. No.: US 2026/0356606 A1
(43) Pub. Date: Nov. 12, 2026

(54) SEPARATION METHOD AND ASSEMBLY METHOD FOR PLATE-SHAPED WORK STORAGE CONTAINER, AND SEPARATION DEVICE, ASSEMBLY DEVICE, AND SEPARATION-ASSEMBLY DEVICE OF PLATE-SHAPED WORK STORAGE CONTAINER

(71) Applicant: SHIN-ETSU ENGINEERING CO., LTD., Tokyo (JP)

(72) Inventor: Keisuke SETO, Niigata (JP)

(73) Assignee: SHIN-ETSU ENGINEERING CO., LTD., Tokyo (JP)

(21) Appl. No.: 19/630,975

(22) Filed: Mar. 27, 2026

(30) Foreign Application Priority Data
May 9, 2025 (JP) 2025-078722

(51) Int. Cl. B65G 59/10

(52) U.S. Cl. CPC B65G 59/10

(57) ABSTRACT

A separation or assembly method for separating or assembling constituent components of a plate-shaped work storage container, in which the separation of the constituent components is performed in a downflow environment, and a separation operation is executed such that the separation operation moves in an operation direction along the downflow, or the assembly of the constituent components is performed in a downflow environment, and an assembly operation is executed such that the assembly operation moves in an operation direction along the downflow, thereby solving the problem.

### TECHNICAL FIELD

The present invention relates to a separation method and an assembly method for a plate-shaped work storage container such as a blank substrate or a mask substrate used for a silicon wafer substrate and a semiconductor mask, and a separation device, an assembly device, and a separation-assembly device of the plate-shaped work storage container.

### Background Art

In the related art, for example, as shown in Patent Document 1, a storage container that stores, transports, or stores for preservation a plate-shaped work such as a silicon wafer substrate or a mask substrate while maintaining cleanliness of the plate-shaped work is known.

### Related art Document

### Patent Document

[Patent Document 1] JP-A-H8-148551

### SUMMARY OF THE INVENTION

### Problem that the Invention is to Solve

The storage container described in Patent Document 1 includes a filter that captures a gaseous impurity in a gas discharge hole and a gas supply hole through which an atmospheric gas enters and exits, and replaces a gas containing an impurity in the storage container with the atmospheric gas to remove the impurity, and is a large and complex apparatus. Meanwhile, since the separation or the assembly of the storage container performed to insert the plate-shaped work is performed by a manual operation by an operator, an impurity may be mixed into the storage container during opening and closing of a lid depending on a skill of the operator. In the technology described in Patent Document 1, although there is an idea of removing the impurity that has entered, there is no idea of preventing the impurity from entering during the separation or the assembly of the storage container.

The present invention is intended to address such problems, and has an object to provide a separation method and an assembly method of a plate-shaped work storage container, and a separation device, an assembly device, and a separation-assembly device of the storage container for the plate-like work, in which particles are prevented from entering the storage container when performing opening and closing operations of an upper lid of the storage container for storing plate-shaped work, such as a blank substrate and a mask substrate used for a silicon wafer substrate and a semiconductor mask, into the storage container or taking the plate-shaped work out from the storage container, and when performing operations of storing and removing an inner box for fixedly storing the plate-shaped work.

### Means for solving the problem

In order to achieve such an object, a technical means according to the present invention is a separation method for a plate-shaped work storage container, the separation method including at least the following configuration.

A separation method for a plate-shaped work storage container, the separation method includes separating constituent components of the plate-shaped work storage container, in which the separation of the constituent components is performed in a downflow environment, and a separation operation is executed such that the separation operation moves in an operation direction along the downflow.

In addition, in order to achieve the above object, a technical means according to the present invention is an assembly method for a plate-shaped work storage container, the assembly method including at least the following configuration.

An assembly method for a plate-shaped work storage container, the assembly method includes assembling constituent components of the plate-shaped work storage container, in which the assembly of the constituent components is performed in a downflow environment, and an assembly operation is executed such that the assembly operation moves in an operation direction along the downflow.

In addition, in order to achieve the above object, a technical means according to the present invention is a separation-assembly device of a plate-shaped work storage container, the separation-assembly device including at least the following configuration.

A separation-assembly device of a plate-shaped work storage container, the separation-assembly device being configured to separate and assemble constituent components of the plate-shaped work storage container, in which the separation-assembly device includes a storage container lifting/lowering table on which a storage container main body is placed, upper lid holding means that holds at least an upper lid of the storage container, and a controller, and the controller is configured to control the upper lid holding means to be fixed and the storage container lifting/lowering table to be moved during a separation operation, and to control the storage container lifting/lowering table to be fixed and the upper lid holding means to be moved during an assembly operation.

### Advantage of the Invention

By having such a feature, the present invention exhibits the following effects.

It is possible to provide a separation method and an assembly method of a plate-shaped work storage container, and a separation device, an assembly device, and a separation-assembly device of the storage container for the plate-like work, in which particles are prevented from entering the storage container when performing opening and closing operations of an upper lid of the storage container for storing plate-shaped work into the storage container or taking the plate-shaped work out from the storage container, and when performing operations of storing and removing an inner box for fixedly storing the plate-shaped work.

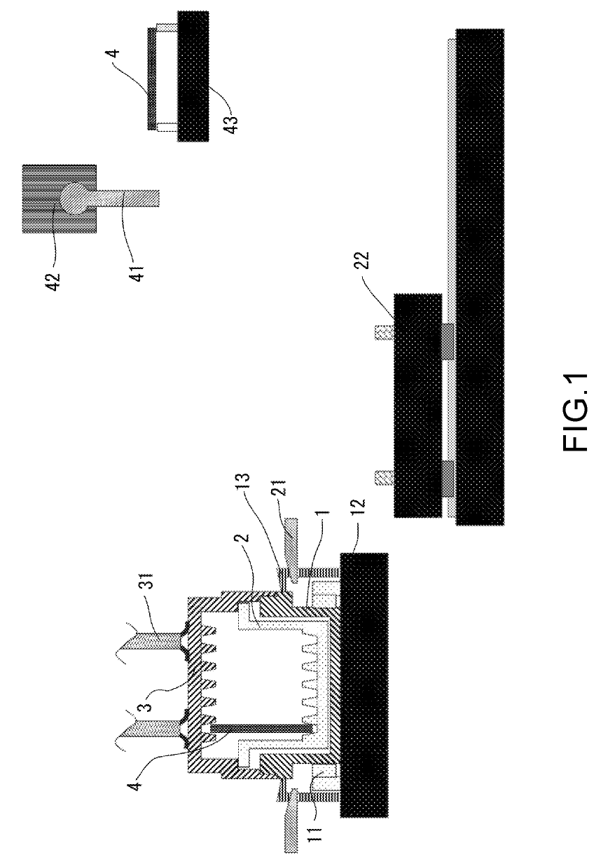

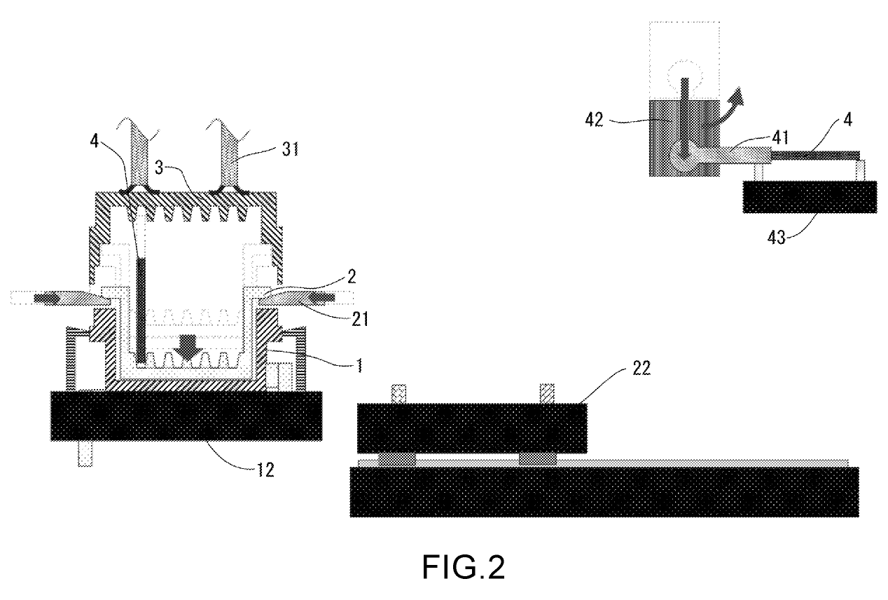

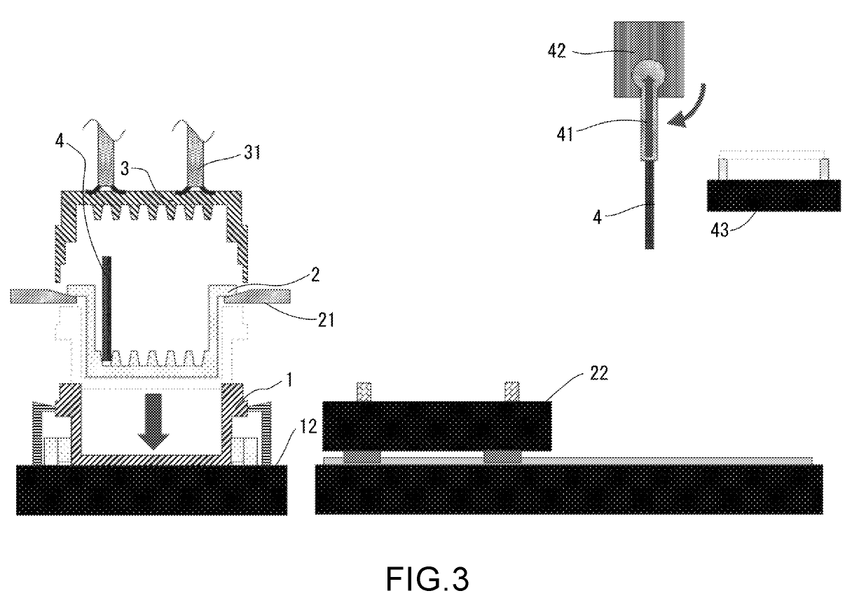

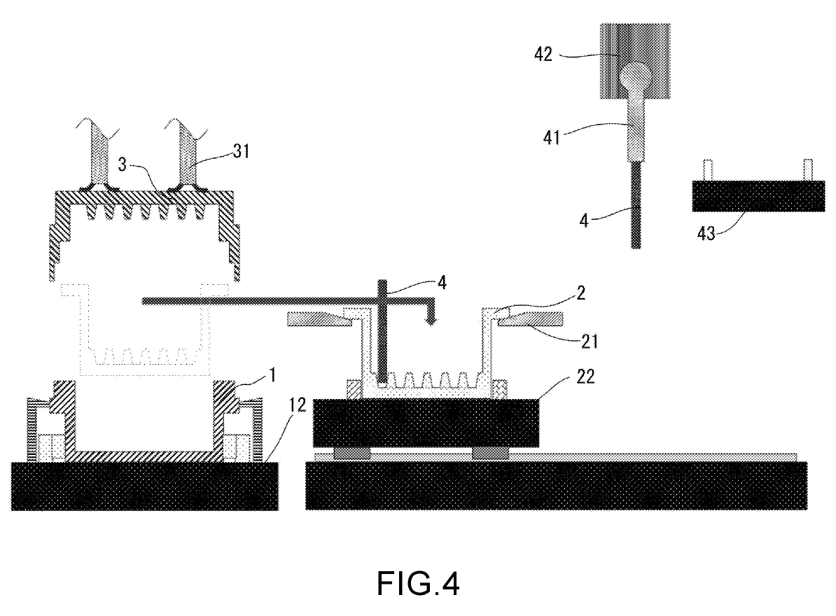

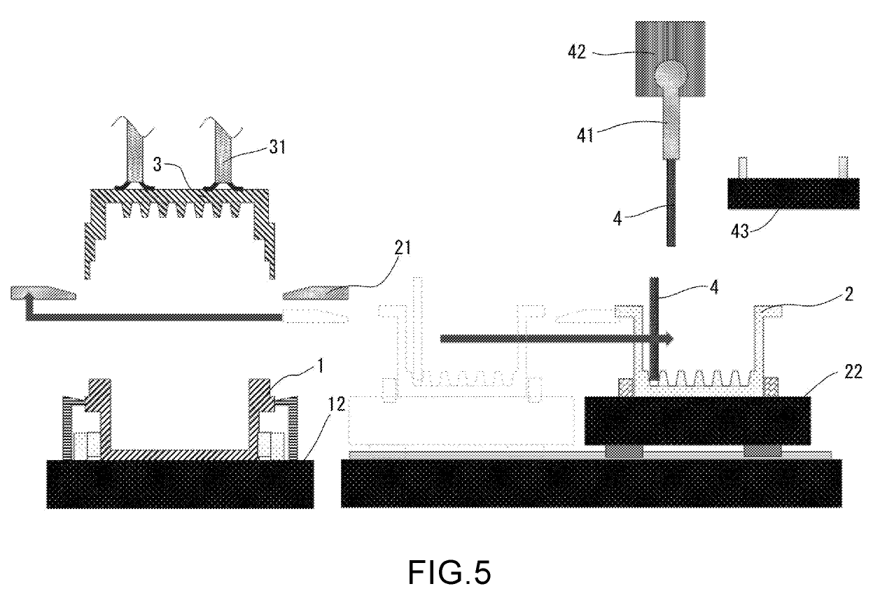

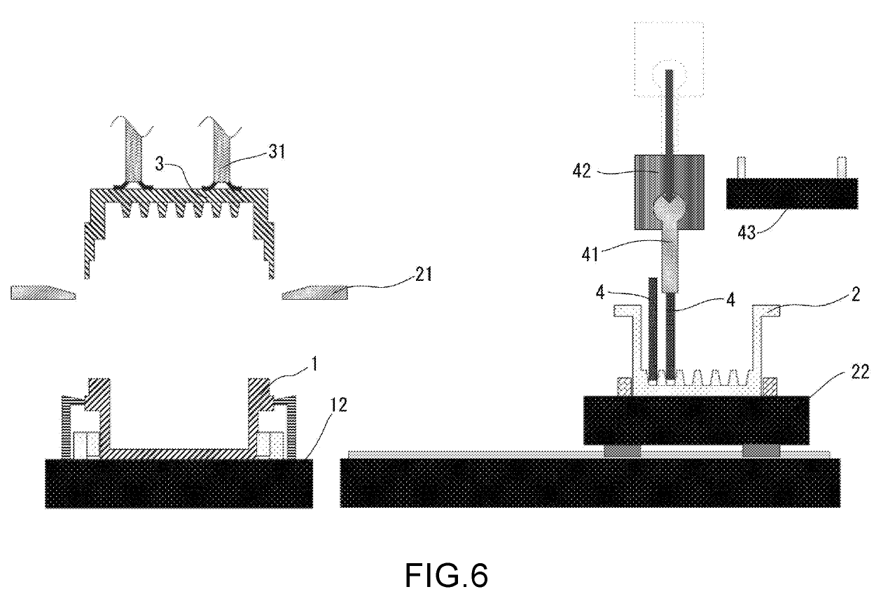

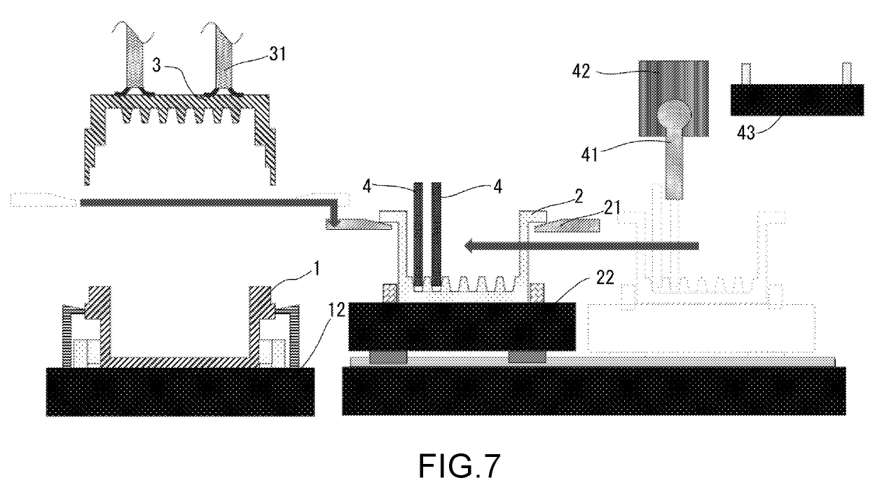

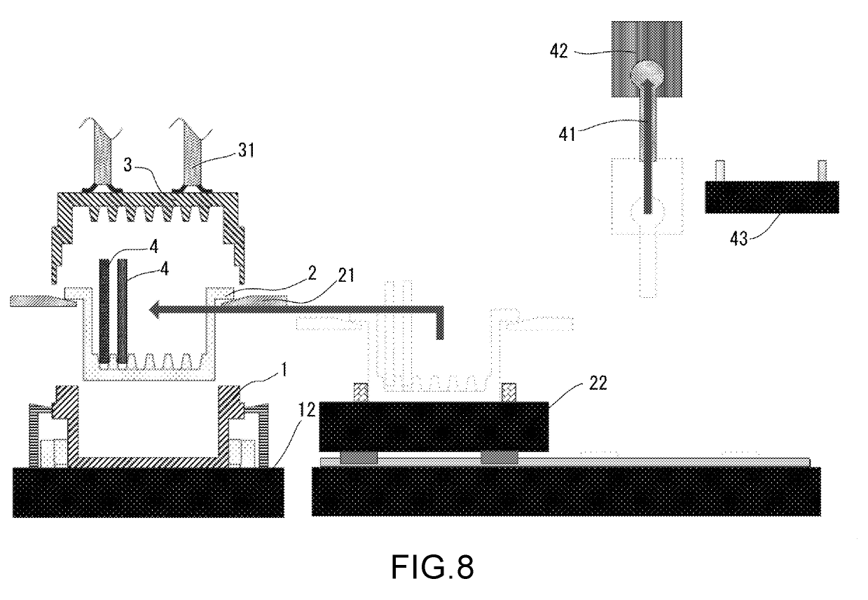

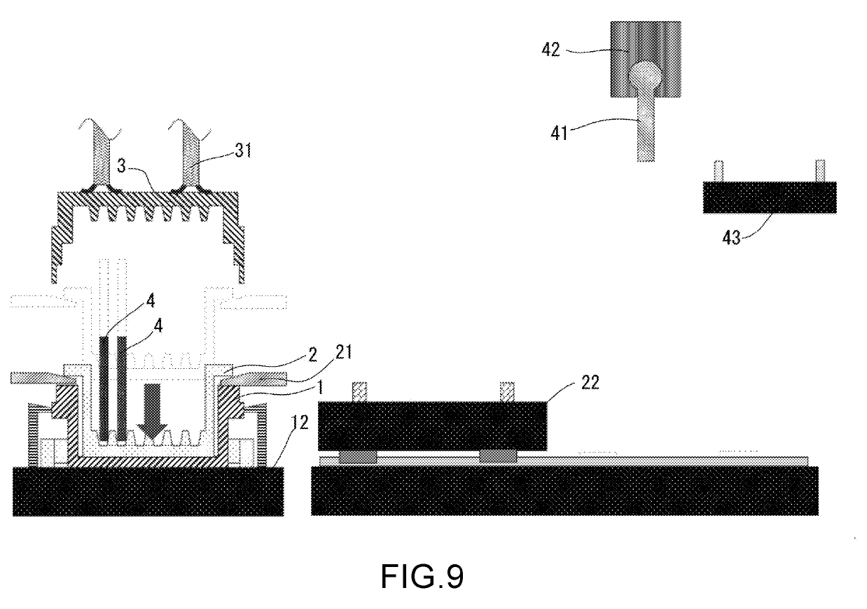

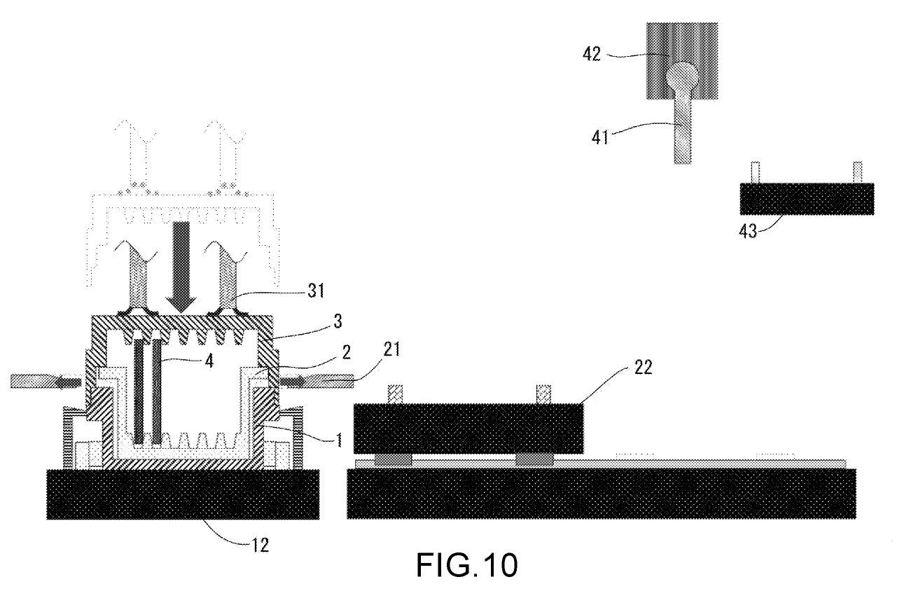

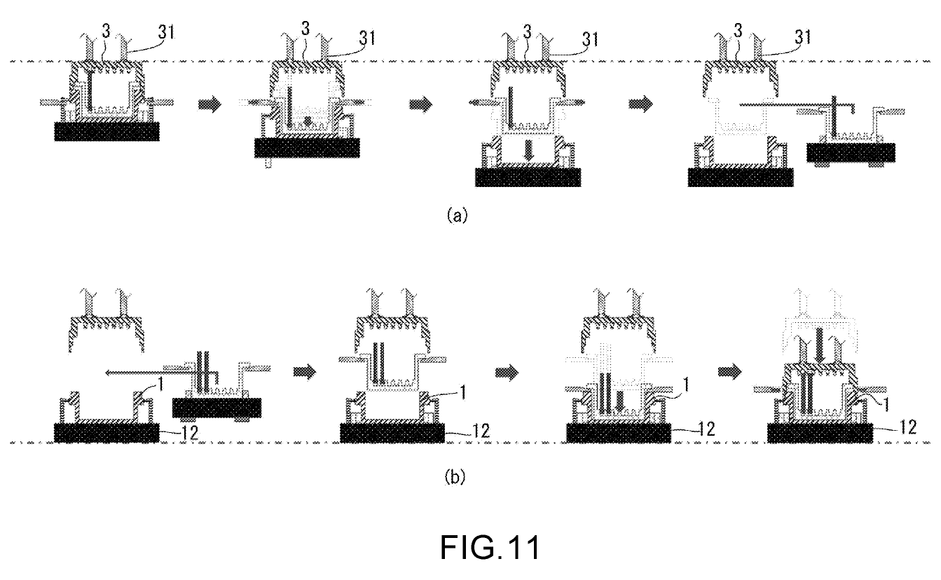

### BRIEF DESCRIPTION OF THE DRAWINGS

[FIG. 1] An explanatory diagram showing a separation-assembly device of a plate-shaped work storage container according to an embodiment of the present invention.

[FIG. 2] An explanatory diagram showing a separation operation in a separation method for a plate-shaped work storage container according to the embodiment of the present invention.

[FIG. 3] An explanatory diagram showing a separation operation in a separation method for a plate-shaped work storage container according to the embodiment of the present invention.

[FIG. 4] An explanatory diagram showing a transfer operation of transferring an inner box from a separation operation position to a plate-shaped work storage position.

[FIG. 5] An explanatory diagram showing a transfer operation of transferring an inner box from a separation operation position to a plate-shaped work storage position.

[FIG. 6] An explanatory diagram showing a storage operation of storing a plate-shaped work in an inner box.

[FIG. 7] An explanatory diagram showing a transfer operation of transferring an inner box from a plate-shaped work storage position to an assembly operation position.

[FIG. 8] An explanatory diagram showing a transfer operation of transferring an inner box from a plate-shaped work storage position to an assembly operation position.

[FIG. 9] An explanatory diagram showing an assembly operation in an assembly method for a plate-shaped work storage container according to the embodiment of the present invention.

[FIG. 10] An explanatory diagram showing an assembly operation in an assembly method for a plate-shaped work storage container according to the embodiment of the present invention.

[FIG. 11] An explanatory diagram showing a change in a height position of a storage container lifting/lowering table during a separation operation and a change in a height position of upper lid holding means during an assembly operation of a separation-assembly device of a plate-shaped work storage container according to the embodiment of the present invention.

### EMBODIMENT FOR CARRYING OUT THE INVENTION

### Environment in case of manufacturing, processing, or the like of plate-shaped work

The present invention relates to a method and a device for preventing particles from entering a storage container when performing opening and closing operations of an upper lid of the storage container for storing plate-shaped work into the storage container or taking the plate-shaped work out from the storage container, and when performing operations of storing and removing an inner box for fixedly storing the plate-shaped work. In order to understand the present invention, it is necessary to understand the environment in a case of manufacturing, processing, or the like of the plate-shaped work, and thus this point will be described first.

A so-called clean room in which the plate-shaped work is manufactured or the like is equipped with a mechanism that prevents particles from entering by using an ultra-high performance filter and that removes particles by air circulation, and particularly, a so-called downflow method that is a vertical unidirectional flow method with a high cleanliness effect is often adopted, and a fan filter unit (FFU) is provided on a ceiling, and a downflow at a predetermined wind speed is generated.

In the United States Federal Standard (FED standard), which is mainstream in the semiconductor industry, the cleanliness is classified according to the number of particles having a size of 0.5 μm or more in the air per cubic foot, and for example, in a case where the number of particles is less than 1,000, the cleanliness is classified as class 1,000, and in a case where the number of particles is less than 10, the cleanliness is classified as class 10. In a semiconductor process in which the storage container is used, particularly in a process in which a silicon wafer or a mask blank is used, a cleanliness stricter than class 10 is required. In a case where even a small particle adheres to a silicon wafer, there is a problem that a yield of a semiconductor product using the silicon wafer is reduced and productivity is reduced. In addition, in a case where even a small particle adheres to a mask blank, a circuit error always occurs in a portion where the particle adheres in an exposure step of baking a circuit on a silicon wafer, and thus a significant influence is exerted on a semiconductor manufacturing process.

In order to maintain the cleanliness of the clean room, it is important to follow four principles of not bringing in particles, not generating particles, not depositing particles, and removing particles. The adoption of the downflow method is effective for those four principles. However, as described above, since the separation or the assembly of the storage container performed to insert the plate-shaped work is performed by a manual operation by an operator, particles may be mixed into the storage container depending on a skill of the operator.

Specifically, the operator may operate the upper lid to be rubbed against the body during opening and closing of the upper lid, or may make a mistake in orientation, and thus particles are likely to be generated due to the rubbing between the upper lid and the storage container main body or due to the intervention of a person, and the generated particles may be mixed into the storage container or may adhere to the plate-shaped work that is a product.

Therefore, as a result of visualizing the vortex entrainment in a case of separating or assembling the storage container and performing the air flow analysis by the present inventor, it was found that, in a case where a movement against the downflow is performed in a case of opening and/or closing the upper lid from the storage container main body or in a case of storing or removing the inner box in the storage container main body, the air flow enters in a vortex, and particles are likely to be mixed in by being entrained in the generated air flow. Then, the present inventor has found that there is an optimal method in a case of performing the separation or the assembly.

The present invention solves the problem by a method for performing only movement in an operation direction along a flow of a downflow in a case of separating or assembling constituent components of a plate-shaped work storage container. Hereinafter, a method for preventing particles from being mixed will be specifically described by an embodiment according to the present invention.

### Embodiment

An embodiment according to the present invention will be described in detail with reference to the drawings, but the following drawings are created for the purpose of description, and members that are not necessary for the description may be intentionally not illustrated for ease of understanding. In addition, the members may be intentionally shown in an enlarged or reduced scale for description, and the drawings do not show an exact scale. In the following description, the same reference numerals in different figures denote the parts having the same functions, and the duplicated description thereof will be omitted as appropriate.

FIG. 1 is an explanatory diagram showing a separation-assembly device of a plate-shaped work storage container according to an embodiment of the present invention. FIG. 1, as a whole, shows a space in which the plate-shaped work is manufactured, processed, or the like.

On the left side in FIG. 1, a separation-assembly device of a plate-shaped work storage container according to the embodiment of the present invention and a state in which the plate-shaped work storage container is placed on the separation-assembly device are shown. A lower right side in FIG. 1 shows an inner box transfer table 22, and an upper right side in FIG. 1 shows a mechanism that processes the plate-shaped work.

### Configuration of plate-shaped work storage container and configuration of separation-assembly device

According to the present embodiment, the plate-shaped work storage container is composed of a storage container main body 1, an inner box 2, and an upper lid 3. However, this is merely an example, and a container composed of a storage container main body and an upper lid without including the inner box is also included in the present invention.

An upper surface of the storage container main body 1 is open. The upper lid 3 is fitted and locked to an opening surface of the storage container main body 1 to seal the plate-shaped work storage container. The upper lid 3 and the storage container main body 1 are configured to be moved to be spaced from each other while both side surfaces of the storage container main body 1 are pressed, so that the locked state of both of them is released.

The inner box 2 is stored in the storage container main body 1 and is composed such that the plate-shaped works 4 do not interfere with each other in a parallel positional relationship. Specifically, the inner box is a type of inner box that stores the plate-shaped work in a vertical direction. In addition, the inner box 2 has an edge portion for being fixed and held by inner box holding arms 21 to be described later, and a space for the inner box holding arms 21 to enter is provided between the edge portion and an upper surface of the storage container main body 1. The inner box 2 is a type that stores the plate-shaped work in a vertical direction, and contact portions of the plate-shaped work are in a left-right direction and is largely open in an up-down direction, so that the downflow passes through the inner box from the top to the bottom, and the storage or the removal of the plate-shaped work can be performed in a state of maintaining the cleanliness. Further, the removed inner box 2 can be processed by a washing device in a state in which the plate-shaped work is stored, and can be subjected to a washing step, immersion in a liquid agent, or the like.

The separation-assembly device of a plate-shaped work storage container according to the embodiment of the present invention includes a storage container fixing mechanism 11, a storage container lifting/lowering table 12, inner box holding arms 21, and upper lid holding means 31. The fixing or holding means are moved by a mechanism portion (not shown). In addition, the separation-assembly device includes a controller (not shown) that controls the fixing or holding means and the mechanism portions thereof.

The storage container fixing mechanism 11 is means for fixing the storage container main body 1 on the storage container lifting/lowering table 12. In the present embodiment, the storage container main body 1 is configured to be held by being pressed from both left and right sides, but a locking portion may be provided in the storage container fixing mechanism 11, and a locked portion may be provided on a side surface of the storage container main body 1. The storage container lifting/lowering table 12 moves or fixes and holds the storage container main body 1 in the up-down direction in cooperation with the storage container fixing mechanism 11. In addition, the storage container lifting/lowering table 12 also includes upper lid release arms 13 for releasing the locked state between the storage container main body 1 and the upper lid 3 by pressing the storage container main body 1 from both side surfaces.

Since the storage container has various sizes depending on the variety of the plate-shaped work, it is desirable that the storage container fixing mechanism can fix and hold the storage container main body according to the size. In a case of changing the size, the size is changed by changing the operation recipe, replacing the attachment of the storage container fixing mechanism, or the like. The storage container fixing mechanism is movable in the up-down direction.

The inner box holding arms 21 include a pair of arms, and they move to approach or separate from the inner box 2 in the left-right direction to hold the inner box 2. In the present embodiment, one of the pair of arms is configured to approach or separate by sliding movement, and the other is configured to approach or separate by rotational movement, and a space is not required on the right side in the drawing. However, in a case where there is no restriction such as a space, an aspect in which both of the arms are moved by sliding is not excluded. Similarly, an aspect in which both of the arms are rotated is not prevented. The inner box holding arms 21 can move the inner box 2 in the up-down direction and the left-right direction.

Since the storage container has various sizes depending on the variety of the plate-shaped work, it is desirable that the inner box holding arms can fix and hold the inner box according to the size. In a case of changing the size, the size is changed by changing the operation recipe, replacing the attachment of the inner box holding arms, or the like. The inner box holding arms are movable in the left-right direction in addition to being movable in the up-down direction, in order to transfer the inner box to the transfer table.

The upper lid holding means 31 holds the upper lid 3 by being suctioned to a top surface of the upper lid 3 by a mechanism such as a negative pressure or a suction pad. The upper lid holding means 31 moves or fixes and holds the upper lid 3 in the up-down direction.

Since the storage container has various sizes depending on the variety of the plate-shaped work, it is desirable that the upper lid holding means can fix and hold the upper lid regardless of the size of the upper lid. In a case of changing the size, the size is changed by changing the operation recipe, replacing the attachment of the upper lid holding means, or the like. The upper lid holding means is movable in the up-down direction.

The controller executes control of the mechanism portion such that, in a case where the plate-shaped work storage container is separated, the upper lid holding means 31 is fixed and the storage container lifting/lowering table 12 is moved, and in a case where the plate-shaped work storage container is assembled, the storage container lifting/lowering table 12 is fixed and the upper lid holding means 31 is moved. In the control of the mechanism portion of the inner box holding arms 21, the mechanism portion is controlled such that the inner box holding arms 21 are moved in both the separation operation and the assembly operation.

### Inner box transfer table and plate-shaped work processing mechanism

The inner box transfer table 22 is configured to receive and place the inner box 2 moved in the left-right direction by the inner box holding arms 21 and to transfer the inner box 2 to the plate-shaped work storage position. The plate-shaped work processing mechanism is composed of a work gripping arm 41, a work gripping arm lifting/lowering mechanism 42, and a work placement table 43. The work placement table 43 is configured to support an end portion of the blank substrate with a plurality of pins, and the blank substrate is placed on the work placement table 43 in the horizontal direction.

### Separation operation of plate-shaped work storage container

The separation operation of the plate-shaped work storage container will be described. The separation of the constituent components of the plate-shaped work storage container is performed in a downflow environment, and the separation operation moves in an operation direction along the flow of the downflow.

FIGS. 1 to 3, including FIG. 1 used to describe the separation-assembly device of a plate-shaped work storage container according to the embodiment of the present invention, are explanatory diagrams showing a separation operation in a separation method for the plate-shaped work storage container according to the embodiment of the present invention, and show a state in which the storage container main body 1, the inner box 2, and the upper lid 3 are completely separated from a state in which the upper lid 3 is locked to the storage container main body 1 in stages.

In a state (not shown) before FIG. 1, the upper lid holding means 31 does not suctioned to the top surface of the upper lid 3, and the upper lid 3 is locked to the storage container main body 1. In FIG. 1, the upper lid release arms 13 provided on the storage container lifting/lowering table 12 are in a state of being in contact with the storage container main body 1, but in a case where the upper lid release arms 13 are moved to press both side surfaces of the storage container main body 1 from this state, the locked state of the upper lid 3 to the storage container main body 1 is released. However, since the storage container lifting/lowering table 12 that supports the storage container main body 1 is at a sufficiently high position, the upper lid 3 is in a state of being in contact with the upper edge of the storage container main body 1. In this state, the storage container lifting/lowering table 12 starts to descend, and the storage container main body 1 supported by the storage container lifting/lowering table 12 also starts to descend.

As shown by the downward arrow in FIG. 2, in a stage in which the storage container main body 1 has descended to a position where the space into which the inner box holding arms 21 fit is exposed, the controller executes control of causing the inner box holding arms 21 to approach the inner box 2. In the drawing, left and right arrows of the same size are drawn to face each other, but in reality, the right arm approaches by rotation, and the left arm approaches by sliding movement. In a case where the inner box 2 is held by the inner box holding arms 21, the height position of the inner box 2 is maintained, but the storage container lifting/lowering table 12 continues to descend, so that the storage container main body 1 supported by the storage container lifting/lowering table 12 continues to descend.

As described above, the opening of the upper lid 3 from the storage container main body 1 is realized by descending the storage container main body 1, unlike a normal opening operation of lifting the lid upward. Since the movement target is moved in the operation direction along the flow of the downflow, it is possible to sufficiently prevent a vortex caused by a movement against the downflow from being generated and particles from being mixed into the storage container.

While the storage container main body 1 is descending, as shown in the upper right in FIG. 2, the operation of the plate-shaped work processing mechanism also proceeds. Specifically, the work gripping arm lifting/lowering mechanism 42 descends, and then the work gripping arm 41 is rotated to a position where the work gripping arm 41 grips the plate-shaped work 4 supported by the plurality of pins of the work placement table 43. The descending operation of the storage container main body 1 and the operation of the plate-shaped work processing mechanism may be performed in sequence, or may be performed substantially simultaneously in parallel in a case where the processing ability of the controller is high.

In FIG. 3, the storage container lifting/lowering table 12 has descended to the maximum descent position. In this state, as shown in FIG. 3, the upper lid 3 held by the upper lid holding means 31, the inner box 2 held by the inner box holding arms 21, and the storage container main body 1 supported by the storage container lifting/lowering table 12 and held by the storage container fixing mechanism 11 are present at independent height positions without overlapping each other. That is, a state in which the separation of the constituent component of the plate-shaped work storage container is completed is reached.

On the other hand, as shown in the upper right in FIG. 3, the operation of the plate-shaped work processing mechanism also proceeds. Specifically, the work gripping arm 41 that grips the plate-shaped work 4 is rotated to the original position, and the work gripping arm lifting/lowering mechanism 42 ascends. The descending operation of the storage container main body 1 and the operation of the plate-shaped work processing mechanism may be performed in sequence, or may be performed substantially simultaneously in parallel in a case where the processing ability of the controller is high. However, after the work gripping arm lifting/lowering mechanism 42 ascends, the operation of the plate-shaped work processing mechanism is temporarily stopped and put on standby until the inner box 2 is positioned below.

### Transfer operation of transferring inner box to plate-shaped work storage position

The transfer operation of transferring the inner box from the separation operation position to the plate-shaped work storage position will be described. FIGS. 3 to 5, including FIG. 3 described above, are explanatory diagrams showing the transfer operation of the inner box 2, and show a state in which the inner box 2 is transferred from the separation operation position to the plate-shaped work storage position in stages.

In FIG. 3, the inner box 2 at the separation operation position is moved to the position of the inner box transfer table 22 as shown in FIG. 4 by moving the inner box holding arms 21 in the horizontal direction. In this state, the inner box 2 is placed on the inner box transfer table 22 by the inner box holding arms 21 being spaced from the inner box 2. Thereafter, the inner box transfer table 22 slides to the right, and the inner box 2 is transferred to the plate-shaped work storage position as shown in FIG. 5.

### Storage operation of plate-shaped work

The storage operation of storing the plate-shaped work in the inner box will be described with reference to FIG. 6. As shown in FIG. 6, in a case where the inner box 2 is positioned below, the work gripping arm lifting/lowering mechanism 42 descends while the work gripping arm 41 grips the plate-shaped work 4.

As described above, the operation of storing the plate-shaped work in the inner box 2 is executed in a state in which the inner box 2 is removed from the storage container main body 1 and is in a single state. In a case where the inner box 2 is in a single state, the position of the inner box 2 can be accurately determined as compared to a case where the inner box 2 is stored in the storage container main body 1, so that, in a case of storing the plate-shaped work, the storage position is not erroneously determined, and rubbing does not occur, and thus the storage can be reliably performed in a state of maintaining the cleanliness. Further, the inner box 2 of the type that stores the plate-shaped work in a vertical direction has contact portions of the plate-shaped work in the left-right direction and is largely open in the up-down direction, so that the downflow passes through the inner box 2 from the top to the bottom, and the storage of the plate-shaped work can be performed in a state of maintaining the cleanliness.

In addition, in such a storage operation, in a state in which the inner box 2 is present directly below the plate-shaped work 4, the work gripping arm 41 and the work gripping arm lifting/lowering mechanism 42 that grip the plate-shaped work 4 move only in the operation direction along the flow of the downflow, so that it is possible to sufficiently prevent a vortex caused by a movement against the downflow from being generated and particles from being mixed into the inner box 2.

The timing at which the work gripping arm 41 and the work gripping arm lifting/lowering mechanism 42 are returned upward is after the inner box 2 is retracted from the plate-shaped work storage position together with the inner box transfer table 22 as will be described in the next section, so that particles are not mixed into the inner box 2 (see also FIGS. 7 and 8).

### Transfer operation of transferring inner box to assembly operation position

The transfer operation of transferring the inner box from the plate-shaped work storage position to the assembly operation position will be described. FIGS. 6 to 8, including FIG. 6 described above, are explanatory diagrams showing the transfer operation of the inner box 2, and show a state in which the inner box 2 is transferred from the plate-shaped work storage position to the assembly operation position in stages.

The two pieces of work stored in the inner box 2 shown in FIG. 6 are transferred to the left side by the inner box transfer table 22 sliding to the left side. In a position shown in FIG. 7, the controller executes control of causing the inner box holding arms 21 to approach the inner box 2 again. After the holding function of the inner box 2 is taken over from the inner box transfer table 22 to the inner box holding arms 21, the inner box 2 is moved to the assembly operation position as shown in FIG. 8. In the meantime, the work gripping arm lifting/lowering mechanism 42 is raised to the original height position.

### Assembly operation of plate-shaped work storage container

The assembly operation of the plate-shaped work storage container after the inner box 2 is moved to the assembly operation position will be described. The assembly operation of the constituent component of the plate-shaped work storage container is performed in a downflow environment, and the assembly operation moves in an operation direction along the flow of the downflow.

FIGS. 8 to 10, including FIG. 8 described above, are explanatory diagrams showing an assembly operation in an assembly method for a plate-shaped work storage container according to the embodiment of the present invention, and show a state in which the upper lid 3 is locked to the storage container main body 1 from a state in which the storage container main body 1, the inner box 2, and the upper lid 3 are completely separated in stages.

In FIG. 8, the storage container lifting/lowering table 12 has descended to the maximum descent position. In this state, the upper lid 3 held by the upper lid holding means 31, the inner box 2 held by the inner box holding arms 21, and the storage container main body 1 supported by the storage container lifting/lowering table 12 and held by the storage container fixing mechanism 11 are present at independent height positions without overlapping each other.

As a first operation of the assembly operation, the descending operation of the inner box 2 is executed. As shown in FIGS. 8 and 9, the inner box 2 descends to the position of the storage container main body 1 as shown by the downward arrow in FIG. 9 by the inner box holding arms 21 that enter and support the peripheral edge portion of the inner box 2 descending. As described above, since the space for the inner box holding arms 21 to enter is provided between the peripheral edge portion of the inner box 2 and the upper surface of the storage container main body 1, the inner box 2 completely lands on the inner bottom surface of the storage container main body 1.

Thereafter, as shown in FIG. 10, first, the controller executes control of causing the inner box holding arms 21 to be spaced from the inner box 2. In the drawing, left and right arrows of the same size are drawn to be spaced from each other in opposite directions, but in reality, the right arm is spaced by rotation, and the left arm is spaced by sliding movement.

Next, as shown by the large downward arrow in FIG. 10, the upper lid 3 descends to the position of the storage container main body 1 by the upper lid holding means 31 descending.

In a case where the upper lid holding means 31 continues to press the top surface of the upper lid 3 even after the upper lid 3 comes into contact with the storage container main body 1, the upper lid 3 is naturally locked to the storage container main body 1, and the assembly of the storage container main body 1 is completed.

As described above, the operation of closing the storage container main body 1 with the upper lid 3 is realized in the same manner as a normal operation of descending the lid. Since the movement target is moved in the operation direction along the flow of the downflow, it is possible to sufficiently prevent a vortex caused by a movement against the downflow from being generated and particles from being mixed into the storage container.

The prevention of the mixing of particles is clearly shown in FIG. 11. FIG. 11 is an explanatory diagram showing a change in a height position of a storage container lifting/lowering table during a separation operation and a change in a height position of an upper lid holding means during an assembly operation of a separation-assembly device of a plate-shaped work storage container according to the embodiment of the present invention. FIG. 11(a) is an explanatory diagram showing a height relationship of each element in a case where the storage container is separated along a separation step, and FIG. 11(b) is an explanatory diagram showing a height relationship of each element in a case where the storage container is assembled along an assembly step.

From FIG. 11(a), in a case of opening the upper lid 3 from a state in which the upper lid 3 is fitted to the storage container main body 1, it can be seen that the position of the upper lid 3 in the operation direction is fixed and the storage container main body 1 is moved along the operation direction. In addition, in a case of removing the inner box 2 from a state in which the inner box 2 is stored in the storage container main body 1, it can be seen from FIG. 11(a) that the position of the inner box 2 in the operation direction, that is, the height position is fixed and the storage container main body 1 is moved along the operation direction. After the separation is completed, the inner box 2 is moved in the left-right direction.

From FIG. 11(b), in a case of closing the upper lid 3 from a state in which the storage container main body 1 and the upper lid 3 are separated, it can be seen that the position of the storage container main body 1 in the operation direction is fixed and the upper lid 3 is moved along the operation direction. In addition, in a case of storing the inner box 2 from a state in which the inner box 2 is removed from the storage container main body 1, it can be seen from FIG. 11(b) that the position of the storage container main body 1 in the operation direction is fixed and the inner box 2 is moved along the operation direction.

The separation method or the assembly method executed by the separation-assembly device has been described as the embodiment of the present invention, but in a site where the plate-shaped work is processed or the like, there are scenes in which only the plate-shaped work stored in the storage container is taken out, and scenes in which only the plate-shaped work is stored in the storage container in order to transport the processed plate-shaped work. That is, the present invention is not that the separation-assembly method is conceived as an integral concept, and the separation method and the assembly method are conceived independently. Similarly, the embodiment has been described using the separation-assembly device as an example, but a separation device that performs only the separation or an assembly device that performs only the assembly can also be conceived independently.

The separation method and the assembly method for the plate-shaped work storage container, and the separation device, the assembly device, and the separation-assembly device of the plate-shaped work storage container according to the present invention have been described in detail above, but the specific configuration is not limited to these embodiments, and the present invention includes design changes or the like within a range that does not depart from the gist of the present invention. For example, the embodiment has been described as a storage container including an inner box, but a storage container that is composed of only a main body and an upper lid and directly stores the plate-shaped work is also within the scope of the present invention because the separation operation or the assembly operation is moved in the operation direction along the flow of the downflow, so that it is possible to prevent a vortex caused by a movement against the downflow from being generated and particles from being mixed into the storage container. In addition, the device configuration is also established as the separation method for the present invention, in which a jig that holds at least the upper lid at a fixed position is prepared, and the operator performs an operation of lowering the storage container main body directly below. In addition, in the embodiment, the operation of storing the plate-shaped work in the inner box in a state in which the no plate-shaped work is stored in the storage container has been described as an example, but the plate-shaped work may be taken out from a state in which the plate-shaped work is stored in the inner box in a vertical orientation. Even in this case, the operation of taking out the plate-shaped work from the inner box is executed in a state in which the inner box is removed from the storage container main body and is in a single state. In a case where the inner box is in a single state, the position of the inner box can be accurately determined as compared to a case where the inner box is stored in the storage container main body, so that, in a case of taking out the plate-shaped work, the taking-out error or the rubbing does not occur, and the taking- out can be reliably performed in a state of maintaining the cleanliness. Further, the inner box of the type that stores the plate-shaped work in a vertical direction has contact portions of the plate-shaped work in the left-right direction and is largely open in the up-down direction, so that the downflow passes through the inner box from the top to the bottom, and the plate-shaped work can be taken out in a state of maintaining the cleanliness.

In a case of taking out the plate-shaped work 4 from the inner box 2, the inner box 2 is descended together with the inner box transfer table 22 by the lifting/lowering mechanism (not shown) of the inner box transfer table 22, so that the inner box 2 is moved only in the operation direction along the flow of the downflow, so that it is possible to sufficiently prevent a vortex caused by a movement against the downflow from being generated and particles from being mixed into the inner box 2.

As described at the beginning, it has been found that a vortex is generated by a movement against the downflow, and particles are likely to be mixed in by being entrained in the air flow, and the optimal solution in a case of performing the separation or the assembly has been found, and the technical significance of the present invention that various problems in the related art have been overcome thereby should be correctly evaluated. In addition, it should be fully noted that the present invention should not be understood as being applicable only in a situation where both separation and assembly of the storage container are performed. The technical significance of the present invention should be understood after correctly recognizing that there are scenes in which only the separation is performed and scenes in which only the assembly is performed depending on the difference in the business type.

### DESCRIPTION OF REFERENCE NUMERALS AND SIGNS

1: storage container main body
2: inner box
3: upper lid
11: storage container fixing mechanism
12: storage container lifting/lowering table
13: upper lid release arm
21: inner box holding arm
22: inner box transfer table
31: upper lid holding means
41: work gripping arm
42: work gripping arm lifting/lowering mechanism
43: work placement table

What is claimed is:

1. A separation method for a plate-shaped work storage container, the separation method comprising:
separating constituent components of the plate-shaped work storage container,
wherein the separation of the constituent components is performed in a downflow environment, and a separation operation is executed such that the separation operation moves in an operation direction along the downflow.

2. An assembly method for a plate-shaped work storage container, the assembly method comprising:
assembling constituent components of the plate-shaped work storage container,
wherein the assembly of the constituent components is performed in a downflow environment, and an assembly operation is executed such that the assembly operation moves in an operation direction along the downflow.

3. The separation method for a plate-shaped work storage container according to claim 1,
wherein the constituent components include at least a storage container main body in which an upper surface is open, and an upper lid that is fitted to an opening surface of the storage container main body to seal the plate-shaped work storage container.

4. The separation method for a plate-shaped work storage container according to claim 3,
wherein in a case of opening the upper lid from a state in which the upper lid is fitted to the storage container main body, the upper lid has a fixed position in the operation direction, and the storage container main body is moved along the operation direction.

5. The assembly method for a plate-shaped work storage container according to claim 2,
wherein the constituent components include at least a storage container main body in which an upper surface is open, and an upper lid that is fitted to an opening surface of the storage container main body to seal the plate-shaped work storage container.

6. The assembly method for a plate-shaped work storage container according to claim 5,
wherein in a case of closing the upper lid from a state in which the storage container main body and the upper lid are separated, the storage container main body has a fixed position in the operation direction, and the upper lid is moved along the operation direction.

7. The separation method for a plate-shaped work storage container according to claim 3,
wherein the constituent components further include an inner box that is stored in the storage container main body, and
the inner box is composed such that the plate-shaped works do not interfere with each other in a parallel positional relationship.

8. The separation method for a plate-shaped work storage container according to claim 7,
wherein in a case of removing the inner box from a state in which the inner box is stored in the storage container main body, the inner box has a fixed position in the operation direction, and the storage container main body is moved along the operation direction.

9. The assembly method for a plate-shaped work storage container according to claim 5,
wherein the constituent components further include an inner box that is stored in the storage container main body, and
the inner box is composed such that the plate-shaped works do not interfere with each other in a parallel positional relationship.

10. The assembly method for a plate-shaped work storage container according to claim 9,
wherein in a case of storing the inner box from a state in which the inner box is removed from the storage container main body, the storage container main body has a fixed position in the operation direction, and the inner box is moved along the operation direction.

11. A separation device of a plate-shaped work storage container, the separation device performing separation of constituent components of the plate-shaped work storage container by the separation method for a plate-shaped work storage container according to claim 1.

12. A separation device of a plate-shaped work storage container, the separation device performing separation of constituent components of the plate-shaped work storage container by the separation method for a plate-shaped work storage container according to claim 4.

13. A separation device of a plate-shaped work storage container, the separation device performing separation of constituent components of the plate-shaped work storage container by the separation method for a plate-shaped work storage container according to claim 8.

14. An assembly device of a plate-shaped work storage container, the assembly device performing assembly of constituent components of the plate-shaped work storage container by the assembly method for a plate-shaped work storage container according to claim 2.

15. An assembly device of a plate-shaped work storage container, the assembly device performing assembly of constituent components of the plate-shaped work storage container by the assembly method for a plate-shaped work storage container according to claim 6.

16. An assembly device of a plate-shaped work storage container, the assembly device performing assembly of constituent components of the plate-shaped work storage container by the assembly method for a plate-shaped work storage container according to claim 10.

17. A separation-assembly device of a plate-shaped work storage container, the separation-assembly device separating and assembling constituent components of the plate-shaped work storage container,
wherein the separation and the assembly of the constituent components are performed in a downflow environment, and a separation operation is executed such that the separation operation moves in an operation direction along the downflow, and an assembly operation is executed such that the assembly operation moves in an operation direction along the downflow.

18. A separation-assembly device of a plate-shaped work storage container, the separation-assembly device being configured to separate and assemble constituent components of the plate-shaped work storage container, the separation-assembly device comprising:
a storage container lifting/lowering table on which a storage container main body is placed;
upper lid holding means that holds at least an upper lid of the storage container; and
a controller,
wherein the controller is configured to control the upper lid holding means to be fixed and the storage container lifting/lowering table to be moved during a separation operation, and to control the storage container lifting/lowering table to be fixed and the upper lid holding means to be moved during an assembly operation.

19. The separation-assembly device of a plate-shaped work storage container according to claim 18, further comprising:
an inner box holding arm that holds an inner box stored in the storage container main body,
wherein the controller is configured to control the inner box holding arm to be moved during the separation operation and during the assembly operation.
